(19) United States
(12) Patent Application Publication
(10) Pub. No.: US 2007/0017150 A1
(43) Pub. Date: Jan. 25, 2007

(54) Insect trapping device

(76) Inventors: Shuji Ohno, Fukuoka-shi (JP); Osamu Araki, Fukuoka-shi (JP); Kohmei Ikari, Fukuoka-shi (JP); Yasuhiro Fujimori, Fukuoka-shi (JP)

Correspondence Address: JORDAN AND HAMBURG LLP, 122 EAST 42ND STREET, SUITE 4000, NEW YORK, NY, 10168, US

(21) Appl. No.: 11/489,361

(22) Filed: Jul. 19, 2006

(30) Foreign Application Priority Data
Jul. 20, 2005 (JP) 2005-209635

(51) Int. Cl. A01M 1/08; A01M 1/02

(52) U.S. Cl. 43/139; 43/113; 43/107

(57) ABSTRACT

A device for trapping insects such as mosquitoes efficiently by gathering and concentrating them and conducting them into a suction inlet. The insect trapping device comprises: a carriage; a post standing on the carriage; a housing bulging forward over the post for sucking and trapping an insect; a suction inlet formed in the bottom face of the front of the housing; and an attractive element disposed below the suction inlet and on the carriage for attracting the insect. A gas cylinder is housed in the post and contains an attractive gas to be emitted from the attractive element. The attractive element is an upward protrusion with a black surface. An ultraviolet emitter is arranged near the suction inlet and emits a ray downward of the housing.

### BACKGROUND OF THE INVENTION

1. Field of the Invention

This invention relates to a system and a device for trapping insects harmful as a sanitary pest by attracting, concentrating and sucking them.

2. Background Art

As a method for protecting a human body against insects such as mosquitoes, there is known a method for applying a repellent called the insect repellent in advance to the clothes or skins, or for transpirating an insect killer containing a desired insecticide component.

The method using the repellent is only to suppress the approach of the insects, and it cannot be a fundamental solution to the problem because the number of insects does not change thereby. In the case that the insects are got rid of by the insecticide, the number of insects can be reduced. However, it is impossible to completely neglect the fear that the insecticide component adversely affects the environment and the human body. This fear may cause hesitancy to use the insecticide for a prolonged period of time.

Therefore, there has been proposed an insect trapping device (as referred to Patent Document 1), in which either an attractive agent made of less harmful chemicals than the insecticide to the human body and the environment, or a light is utilized to attract and trap a specific insect thereby to reduce the practical number of insects.

Patent Document 1: JP-A-6-319424

### SUMMARY OF THE INVENTION

Although the aforementioned insect trapping device can attract the insects, the attracted insects spread across the trapping device they cannot always be concentrated at the area of a physical attraction on the insects. This has made it difficult to trap the insects efficiently.

Therefore, it is an object of the invention to provide a device for trapping insects such as mosquitoes efficiently by concentrating them locally at the trapping area.

According to the invention, there is provided an insect trapping device which comprises: a carriage; a post standing on the carriage; a housing bulging forward over the post for sucking and trapping an insect; a suction inlet formed in the bottom face of the front of the housing; and an attractive element disposed below the suction inlet and on the carriage for attracting the insect.

The insect trapping device of the invention has the following characteristics.

(1) A gas cylinder is housed in the post and containing an attractive gas emitted from the attractive element.

(2) The attractive element is an upward protrusion with a black surface.

(3) An ultraviolet emitter is arranged near the suction inlet of the housing and downward of the housing for emitting an ultraviolet ray.

According to a first aspect of the invention, the insect trapping device comprises: the carriage; the post standing on the carriage; the housing bulging forward over the post for sucking and trapping the insect; the suction inlet formed in the bottom face of the front of the housing; and the attractive element disposed below the suction inlet and on the carriage for attracting the insect. Thus, the insects can be concentratedly gathered around the attractive element to the position below the suction inlet thereby to improve the suction efficiency of the insects by the suction inlet.

The insect trapping device of a second aspect of the invention is according to the first aspect of the invention, wherein the gas cylinder is housed in the post and contains the attractive gas to be emitted from the attractive element. Thus, the attractive gas cylinder can be prevented from being exposed to the outside thereby to improve the appearance of the insect trapping device and to prevent the gas cylinder from being stolen.

The insect trapping device of a third aspect of the invention is according to the first or second aspect of the invention, wherein the attractive element is an upward protrusion with a black surface. By making use of the habit of the insects to fly over the black object protruding upward, the insects can be locally attracted to the vicinity of the protrusion disposed on the lower side of the suction inlet.

The insect trapping device of a fourth aspect of the invention is according to the first aspect of the invention, wherein the ultraviolet emitter is arranged near the suction inlet of the housing and downward of the housing for emitting the ultraviolet ray. The insects having been gathered around the attractive element can be effectively conducted into the suction inlet by the ultraviolet emitter thereby to improve the trapping efficiency better.

### BRIEF DESCRIPTION OF THE DRAWINGS

FIG. 1 is a side elevation of an insect trapping device according to an embodiment of the invention;

FIG. 2 is a front elevation of the insect trapping device according to the embodiment of the invention;

FIG. 3 is a back elevation of the insect trapping device according to the embodiment of the invention;

FIG. 4 is a top plan view of the insect trapping device according to the embodiment of the invention;

FIG. 5 is a schematic vertical section of the insect trapping device according to the embodiment of the invention; and

FIG. 6 is a schematic horizontal section of the insect trapping device according to the embodiment of the invention.

### DESCRIPTION OF THE PREFERRED EMBODIMENT

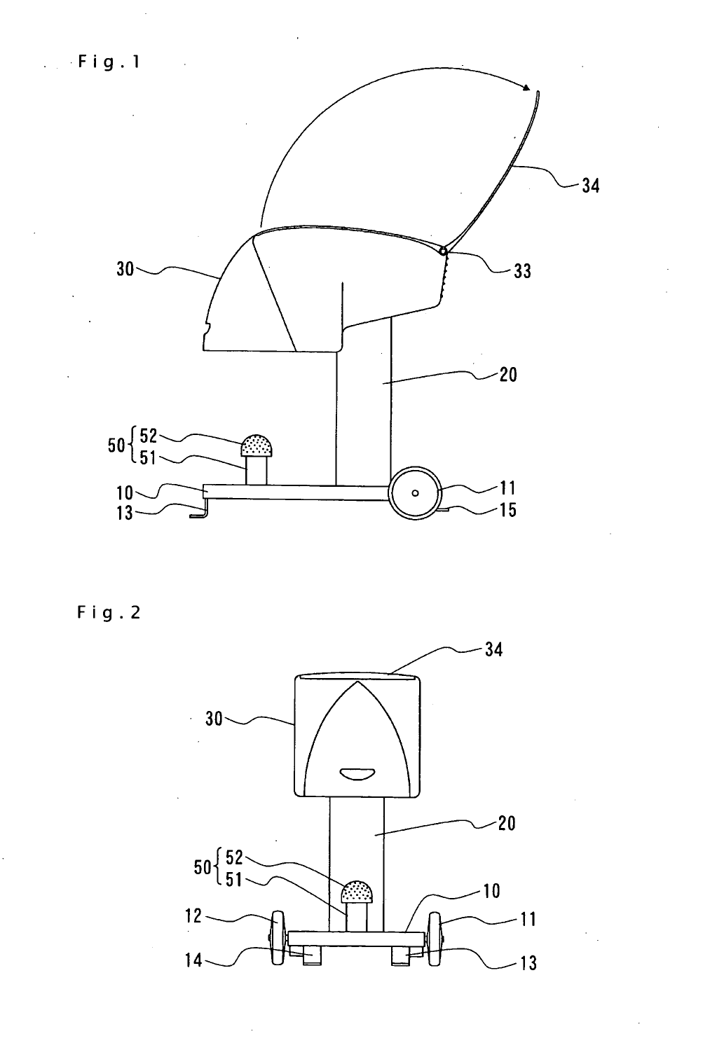

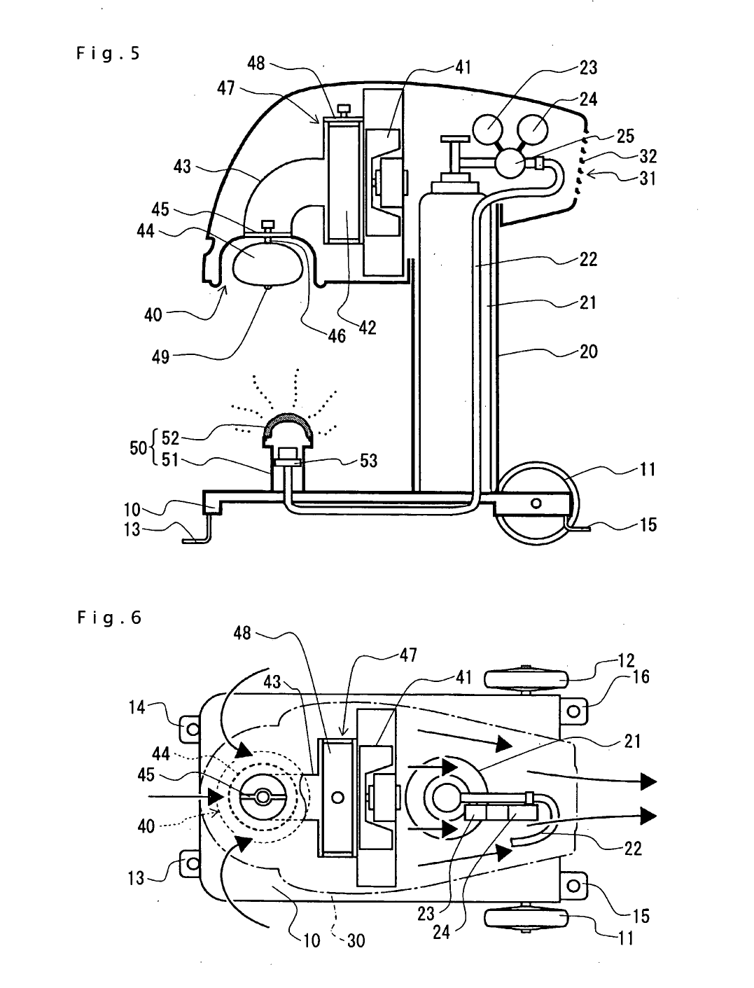

As shown in FIG. 1 to FIG. 4, an insect trapping device of the invention comprises: a flat carriage 10; a post 20 standing on the upper face of the carriage 10; a housing 30 disposed on the post 20 for sucking and trapping the insect; a suction inlet 40 (as referred to FIG. 5) disposed in the bottom face of the housing 30; and an attractive element 50 disposed below the suction inlet 40 and on the carriage 10 for attracting the insect.

The carriage 10 is formed into a flat plate having a rectangular shape in a top plan view, as shown in FIG. 4, and having a desired thickness. A lefthand wheel 11 is hinged to the lefthand rear portion of the carriage 10, and a righthand wheel 12 is hinged to the righthand rear portion of the carriage 10. Moreover, the carriage 10 is provided on its front end lefthand portion with an L-shaped lefthand ground member 13 and on its front end righthand portion with an L-shaped righthand ground member 14.

By thus providing the lefthand and righthand wheels 11 and 12, the insect trapping device can be easily carried. When the front end edge of the carriage 10 is raised, the insect trapping device is carried, while being grounded only at the lefthand and righthand wheels 11 and 12, to a desired position, and is then fixed with the lefthand and righthand ground members 13 and 14 being left in position on the surface of the ground.

The lefthand and righthand ground members 13 and 14 are plate members bent in an L-shape. Each of these plate members has its one end depending from the front end portion of the carriage 10 and its other end protruding forward to provide an abutment portion, at which it abuts against the surface of the ground position. That abutment portion may be provided with a desired through hole, through which the abutment portion may be firmly fixed by a desired pile.

In FIG. 1, numeral 15 designates a lefthand retaining member mounted on the rear end lefthand portion of the carriage 10, and numeral 16 designates a righthand retaining member mounted on the rear end righthand portion of the carriage 10. These lefthand and righthand retaining members 15 and 16 are also provided with the desired through holes so that they can be firmly fixed by using the desired piles.

The post 20 is a cylindrical member standing upward on the upper face of the carriage 10 close to the rear end. As shown in a vertical section of FIG. 5, the post 20 can house a gas cylinder 21 containing an attractive gas.

By housing the gas cylinder 21 in the post 20, the gas cylinder 21 can be made less apparent to improve the appearance of the insect trapping device. It is also possible to prevent the gas cylinder from being stolen.

In FIG. 5 and FIG. 6, numeral 22 designates an attractive gas feed tube connected to a regulator 25 mounted to the gas cylinder 21. Numeral 23 designates a primary pressure meter for measuring the internal pressure of the gas cylinder 21. Numeral 24 designates a secondary pressure meter for measuring the pressure of the attractive gas emitted from the regulator 25.

The housing 30 is a casing mounted on the upper end of the post 20. The housing 30 is formed into such a taper shape as is longitudinally extended and expanded forward. The housing 30 is connected at its rear bottom face to the post 20 and is bulged forward.

The housing 30 is provided at its front bottom face with the suction inlet 40 opened downward, as shown in FIG. 5. By running a suction fan 41 disposed in the housing 30, the air is sucked from the suction inlet 40 into the housing 30.

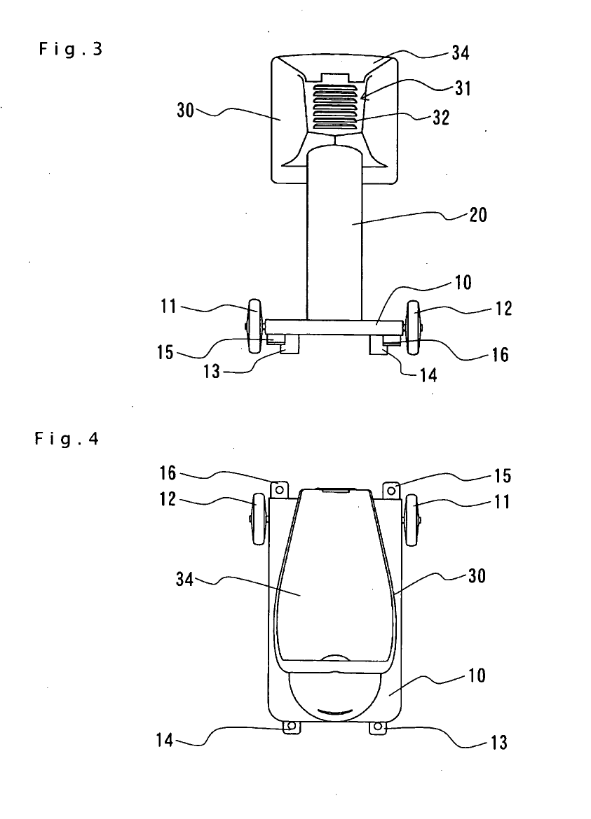

In the rear end portion of the housing 30, as shown in FIG. 3 and FIG. 5, there is formed an exhaust area 31 for exhausting the air sucked into the housing 30. In the exhaust area 31 is provided with a plurality of vanes 32, which are vertically juxtaposed.

The suction fan 41 is disposed at a substantially intermediate portion in the longitudinal direction of the housing 30, and is so arranged just in front of the upper end portion of the gas cylinder 21 housed in the post 20 that the air ventilated backward by the suction fan 41 may blow on the upper end portion of the gas cylinder 21, as shown in FIG. 6.

By thus guiding the wind generated by the suction fan 41 onto the gas cylinder 21, this gas cylinder 21 can be air-cooled so that it can be prevented from being excessively heated even in the case that the insect trapping device is disposed in the hot weather.

In front of the suction fan 41, as shown in FIG. 5 and FIG. 6, there is disposed a trapping unit 47 which has a collection net 42, thereby to trap the insect sucked with the air by the suction fan 41 into the housing 30. The trapping area 47 houses the collection net 42 of a box shape in a removable manner, so that the collection net 42 can be freely brought in and out by removing an opening cover 48 disposed in the upper portion of the trapping area 47. The collection net 42 prevents the insect, which has been sucked into the collection net 42 by the sucking action of the suction fan 41, from escaping to the outside of the collection net 42.

The housing 30 is provided, as shown in FIG. 5, with a cylindrical suction tube 43 connecting its one end to the suction inlet 40, thereby to guide the air sucked from the suction inlet 40 by the a cylindrical suction tube 43 smoothly into the collection net 42.

Especially, the suction tube 43 is expanded on the side of the suction inlet 40, and is provided at the portion of the suction inlet 40 with a central saucer 44 having a flattened spherical shape thereby to form the suction inlet 40 by the central saucer 44 into an annular shape.

Since the suction inlet 40 is formed into the annular shape by the central saucer 44, it is possible to improve the flow velocity of the air to flow between the suction tube 43 and the central saucer 44. Thus, the insect having been sucked from the suction inlet 40 can be prevented from escaping to the outside.

The central saucer 44 is provided with a mounting bolt 46 for mounting the central saucer 44 on a central saucer support 45 disposed in the suction tube 43. The leading end of the mounting bolt 46 is externally threaded, and this external thread portion is inserted into the saucer support 45 and is fixed by suitable fastening means such as a nut.

Moreover, the central saucer 44 is provided, at its leading end center portion on the side of the suction inlet 40, with an ultraviolet emitter 49 for emitting an ultraviolet ray, as shown in FIG. 5. Especially, this ultraviolet emitter 49 is arranged to emit the ultraviolet ray downward of the housing 30.

By thus disposing the ultraviolet emitter 49 at the portion of the suction inlet 40, the insect can be more conducted into the suction inlet 40 by the ultraviolet emitter 49 thereby to improve the trapping efficiency of the insect. In this embodiment, the ultraviolet emitter 49 is exemplified by an ultraviolet LED (Light Emitting Diode). Moreover, although one ultraviolet emitter 49 is employed in this embodiment, a plurality of ultraviolet emitters 49 may be disposed.

The position of arranging the ultraviolet emitter 49 should not be limited to the central portion of the leading end of the central saucer 44 on the side of the suction inlet 40 but may be anywhere if it is near the suction inlet 40 of the housing 30.

Over the housing 30, there is disposed a roof 34, which is so hinged at its one end on a hinge pin 33 disposed at the upper portion of the rear side of the housing 30 can be freely opened. By popping up the roof 34, the upper portion of the housing 30 can be opened to bring the gas cylinder 21 in and out, to mount the collection net 42 to and from, and to mount the central saucer 44 in and out.

The attractive element 50, as disposed over the carriage 10, is constituted, as shown in FIG. 1 and FIG. 5, to include a cylindrical post 51 protruding from the upper face of the carriage 10, and a bulging semispherical member 52 disposed on the upper end portion of that post 51.

In the post 51, as shown in FIG. 5, there is mounted an attractive gas emitter 53, to which the other end of the attractive gas feed tube 22 having its one end connected to communicate with the gas cylinder 21 is connected, so that the attractive gas can be emitted from the attractive gas emitter 53. Here, the attractive gas feed tube 22 is arranged in the post 20 and in the carriage 10, and is connected with the attractive gas emitter 53 without being exposed to the outside, thereby to improve the appearance of the insect trapping device.

The semispherical member 52 is provided on its surface with a number of attractive gas emitting area so that it can emit the attractive gas discharged from the attractive gas emitter 53, in a diffusing manner. Especially, the semispherical member 52 has an inside cavity and emits the attractive gas, as emitted from the attractive gas emitter 53, while residing for a predetermined time period, so that it can diffuse the attractive gas efficiently.

According to this embodiment, moreover, the semispherical member 52 is made of sponge of a porous material so that it can make the attractive gas more diffusive.

Here, the semispherical member 52 need not be necessarily made of a porous material such as the sponge, but may be made of a thin sheet of a metal or plastics. Moreover, the semispherical member 52 need not be necessarily formed to have the semispherical shape but may also be rectangular or conical.

The semispherical member 52 has a black surface. Thus, the attractive element 50 protruding upward is disposed on the upper face of the carriage 10 and has the black surface. In addition to the attractive action by the attractive gas, therefore, the behavior of the insect to fly over the black object protruding upward can be utilized to attract the insect efficiently locally.

Especially, the attractive element 50 is disposed below the suction inlet 40 so that the insect attracted locally by the attractive element 50 can be efficiently sucked from the suction inlet 40 and trapped at the trapping area 47.

In the case that the insect trapping device thus constituted is used, it is stably arranged at first at a desired place.

Next, the insect trapping device begins the emission of the attractive gas from the attractive element 50 and the irradiation of the ultraviolet ray by the ultraviolet emitter 49, and then activates the suction fan 41 to begin the suction of air from the suction inlet 40.

This embodiment uses carbonic acid gas as the attractive gas. The carbonic acid gas may be emitted directly from the gas cylinder 21, or the carbonic acid gas may be produced by burning a combustible substance such as propane gas contained in the gas cylinder 21 and may be emitted.

Moreover, the attractive gas may be mixed with an attractive substance for the insect, such as octenol, lactic acid, butyric acid, butenol or isovaleric acid. The desired attractive substance can be mixed into the carbonic acid gas through the (not-shown) mixing portion in the attractive gas feed tube 22.

The attractive gas need not be emitted at all times but may be intermittently emitted. By thus emitting the attractive gas intermittently, the consumption rate of the carbonic acid gas can be reduced to improve the running efficiency of the insect trapping device.

Specifically, the attractive gas is not emitted if the insects to be trapped are mosquitoes of low daytime activities. Then, the attractive gas is emitted only at night, or the attractive gas emission may imitate the breathing of animals such that the attractive gas of denser carbonic acid gas concentration and the attractive gas of thinner concentration are alternately emitted.

In the insect trapping device of the embodiment, even for a short time having no emission of the attractive gas, the attractive gas is gradually emitted by the semispherical member 52 of the attractive element 50 so that the attracted insect can be prevented from leaving the device.

Thus, the insect trapping device of this embodiment can attract the insect from a relatively long distance with the attractive gas. The insect thus attracted to the vicinity of the device is caused to fly over the attractive element 50 by the attraction of the attractive element 50.

The insect flying over the attractive element 50 is sucked from the suction inlet 40 disposed over the attractive element 50, so that it is trapped by the trapping area 47. At this time, the insect is attracted into the suction inlet 40 by the ultraviolet emitter 49 disposed near the suction inlet 40, thereby to improve the suction efficiency of the insect.

The insect thus trapped by the trapping area 47 is disabled to escape to the outside of the collection net 42 by the sucking actions of the suction fan 41 so that the insect can be reliably trapped.

Especially, the insect trapping device is enabled to establish an air flow of a high speed by improving the rotating speed of the suction fan 41 at a predetermined timing. As a result, the insect trapped in the trapping area 47 can be crushed or dried to death with the air flow so that the insect can be prevented from escaping to the outside from the trapping area 47, as the suction fan 41 stops.

Although not shown, the battery for supplying the electric power to drive the suction fan 41, the suction fan 41, the ultraviolet emitter 49 and the control unit for controlling the attractive gas emission are housed in the housing 30, so that they are air-cooled like the gas cylinder 21 with the wind established by the suction fan 41.

The invention should not be limited to the aforementioned embodiment but may contain modes having the desired portions suitably modified.

What is claimed is:

1. An insect trapping device comprising:
a carriage;
a post standing on said carriage;
a housing bulging forward over said post for sucking and trapping an insect;
a suction inlet formed in the bottom face of the front of said housing; and
an attractive element disposed below said suction inlet and on said carriage for attracting said insect.

2. An insect trapping device according to claim 1,
wherein a gas cylinder is housed in said post and contains an attractive gas to be emitted from said attractive element.

3. An insect trapping device according to claim 1 or 2,
wherein said attractive element is an upward protrusion with a black surface.

4. An insect trapping device according to claim 1, further comprising an ultraviolet emitter arranged near the suction inlet of said housing and downward of said housing for emitting an ultraviolet ray.
